(19) United States
(12) Patent Application Publication
(10) Pub. No.: US 2008/0185403 A1
(43) Pub. Date: Aug. 7, 2008

(54) Dispensing container for flowable product

(76) Inventors: Hermann Goetz, Ruesselsheim (DE); Bruno Ackermann, Nieder-Olm (DE); Dieter Folland, Hochheim (DE)

Correspondence Address: DeMont & Breyer, LLC, 100 Commons Way, Ste. 250, Holmdel, NJ, 07733, US

(21) Appl. No.: 11/945,918

(22) Filed: Nov. 27, 2007

Related U.S. Application Data
(63) Continuation-in-part of application No. PCT/EP2006/004882, filed on May 23, 2006.

(30) Foreign Application Priority Data
May 27, 2005 (DE) 20 2005 008 465.4

(51) Int. Cl. G01F 11/26

(52) U.S. Cl. 222/456; 222/454

(57) ABSTRACT

A dispensing container for flowable product in a basic polyhedronorm having at least an edge, or as a three-part can including a container sidewall, a container bottom and a container cover. The container includes, in its interior, a discharging device for dispensing portions of product. The dispensing container can be sealingly closed.

### FIELD OF THE INVENTION

The invention relates to a dispensing container for flowable products such as fluent solids, comprising container sidewalls, a container bottom, a container top wall and discharge means for dispensing the flowable product from the dispensing container.

The invention also relates to a container basic body that can be used in a flexible manner, that is, used with the dispensing container of invention, but also in a conventional manner.

### BACKGROUND OF THE INVENTION

Dispensing containers (DE-A 1,671,115, AT-B 204,208, AT-B 227,398, CH-B 338,936) are known as dispensers for sugar and include a screwable closure having a mid discharging tube, the lower end thereof extending into the container and form a metering opening that may be slanted. There are examples having facilities to adapt the width of the metering opening at the lower end of the discharging tube. By tipping of the container, a predetermined quantity of sugar can be dispensed as far as the filling level within the container is above this metering opening. It is not possible to completely empty the dispensing container by tipping. Such dispensing containers are intended to be refilled and therefore include a screwable closure.

A further dispensing container is known from U.S. Pat. No. 2,148,421 and includes a jar of glass, a threaded cover and a discharge tube that is fixed at the cover eccentrically to the axis of the jar. The discharge tube is formed with an inverted funnel, the lower edge thereof is disposed close to the bottom of the jar and includes an adjustable plate to adjust the funnel opening. The self-measuring dispenser is not configured as a selling package.

U.S. Pat. No. 2,425,142 shows circular cylindrical dispensing containers of glass or plastics including a measuring and dispensing device constructed on the principle of a measuring cup that is connected with a discharge tube. The dispensing container cannot be emptied completely through the dispensing device and therefore does not lend itself for a selling package.

A narrow box of cardboard or plastics is known from GB 945,471 and internally divided by a U-shaped cardboard wall into two compartments, the smaller narrow compartment extending along the narrow sidewall of the container and forming a discharging device. The transverse wall extends from one larger side to the other larger side of the container. In the case of wider boxes, space consumption for the discharging device is disadvantageously big. For dispensing of fluent solids, a flap is opened, and the box is tipped about its narrow side. Soap is mentioned as the good to be sold. Air-tight closing of the container after opening is not provided. The box therefore is not adapted for packaging finer goods, for example coffee powder.

In the packaging industry, generally the problem exists of presenting, at low costs, of portions of good that is packaged in a selling quantity. Often, good is packaged in single portions, and these single packaged portions are once more packaged in an outer package for being sold. Packaging expenditure would be reduced, if one succeeded to construct dispensing containers that are able to dispense filled-in good in portions and can be emptied completely by tipping the container.

### SUMMARY OF THE INVENTION

It is an object of the present invention to provide a dispenser container useful as a selling package. It is another object to provide a dispensing container with a product in it that can be dispensed in equal portions and emptied practically completely. It is a further object of the invention to provide a dispensing container useful to keep delicate products. It is still a further object to provide a basic corpus for a dispenser container that can be stacked.

The dispenser container of invention includes a discharge device arranged in the interior of the container which, therefore, can also be termed “discharge insert”. In particular, the discharge insert for dispensing good in portions forms a shaft that extends from an opening in the container cover to the container bottom and has a metering opening near the rim of the container bottom. When the dispenser container is tipped obliquely, the container bottom forms a sliding surface transporting a portion of the good into the metering opening. When the dispensing container is completely tipped or dumped, this portion is dispensed through the shaft. By positioning the metering opening at the rim of the container bottom, that partially limits the metering opening, it is possible to feed the total content of the dispensing container outwardly by skillful manipulating of the dispenser container.

The discharge insert can be made up from molded plastics, but it is also possible to produce it from other materials like sheet material, multilayer material or pasteboard. The shaft of the discharge insert extends near the container wall or directly along the container wall. The shaft may be an integral portion of the container sidewall. In such a case, the shaft can take a rectangular cross section. However, also circular or elliptic cross sectional forms are possible to be used, the shaft being constructed as a tube.

The discharge insert may also include a slider so as to adjust the size of the metering opening. Thus, the size of the dispensed portion can be adjusted by one and the same discharge insert. This can be done in the factory for different fill-in products, or the customer may adjust his wanted portion quantity subsequently. Thus, the customer may chose the quantity of coffee at morning differently than that at evening.

The metering opening advantageously is a diagonally cut funnel at the inlet to the shaft, the funnel opening to the central portion of the container bottom. Such shape of the metering opening makes it easy to introduce product into the shaft.

Since the shaft extends along the container sidewall, it is practical to arrange the dispensing opening in the container cover near the rim of the container cover. According to its use, this dispensing opening may be a spout at a tamper-proof dispensing container, the dispensing opening practically being provided with a breakable covering. In this case it is possible, after breaking the covering sheet or foil, to close the dispensing opening by an additional cover for the dispensing opening. This dispensing opening cover may comprise a hinged cover and a seal encircling the dispensing opening. The hinged cover expediently is fastened at the container cover by a molded film web as a hinge. Opposite to the hinge, the rim of the hinged cover is formed with an undercut so as to latch behind a flange of the dispensing container.

With a can-like dispensing container that is not refillable, it is expedient to fix the container lid together with the discharge insert in a first step at the container sidewall so as to make up a hollow item wherein the product to be dispensed is filled in and which is enclosed by the container bottom in a second step.

It is also possible to construct the dispensing container as a tube bag having a frame in the interior thereof which is a portion of the discharge insert.

When using injection-molded containers, a basic container body including container sidewalls and container bottom and additional guiding wall portions is preferably made up so as to use this basic body relative universally, that is, with or without the discharge insert. For that purpose, the basic body comprises guiding wall portions in its interior so that the discharge insert can be coupled onto the shaft for dispensing the product, if desired.

### BRIEF DESCRIPTION OF THE DRAWINGS

Embodiments of the invention will be described with a look onto the drawings, in which:

FIG. 1 is a refillable dispensing container similar to prior art, partially in section, and in a side view,

FIG. 2 is a perspective view onto a can as a dispenser container,

FIG. 3 is a perspective view of the can without can bottom and put onto the can lid,

FIG. 4 is a discharge insert in enlarged scale, seen diagonally from below,

FIG. 5 is a box-like container, obliquely seen from above, the lower portion being broken away,

FIG. 6 is a sectional view according to line A-A in FIG. 5,

FIG. 7 is a sectional view along line B-B in FIG. 5,

FIG. 8 is a bag configured as a dispensing container,

FIG. 9 is a discharge insert having a variable metering opening in a first position,

FIG. 10 is the discharge insert in a second position,

FIG. 11 is a top view onto the discharge insert,

FIG. 12 is a top view onto a slider of the discharge insert,

FIG. 13 is a modification of the discharge insert with a metering opening adjusted small,

FIG. 14 is the metering opening adjusted big,

FIG. 15 is a further box-like dispenser container without cover,

FIG. 16 is the dispensing opening somewhat enlarged,

FIG. 17 is a perspective view on the dispenser container of FIG. 15,

FIG. 18 is the dispenser container in open condition,

FIG. 19 is a sectional view through a modification of the discharge insert,

FIG. 20 is a further example of a dispenser container,

FIG. 21 shows the gripping of the container dispenser of FIG. 20 for right-handers and left-handers,

FIG. 22 is a blank of flat material for the body of the dispenser container,

FIG. 23 is the blank for the shaft of the container,

FIG. 24 is an intermediate step when folding a box,

FIG. 25 is a further intermediate step,

FIG. 26 is a perspective view of the box, and

FIG. 27 shows operation of the box.

### DETAILED DESCRIPTION OF PREFERRED EMBODIMENTS

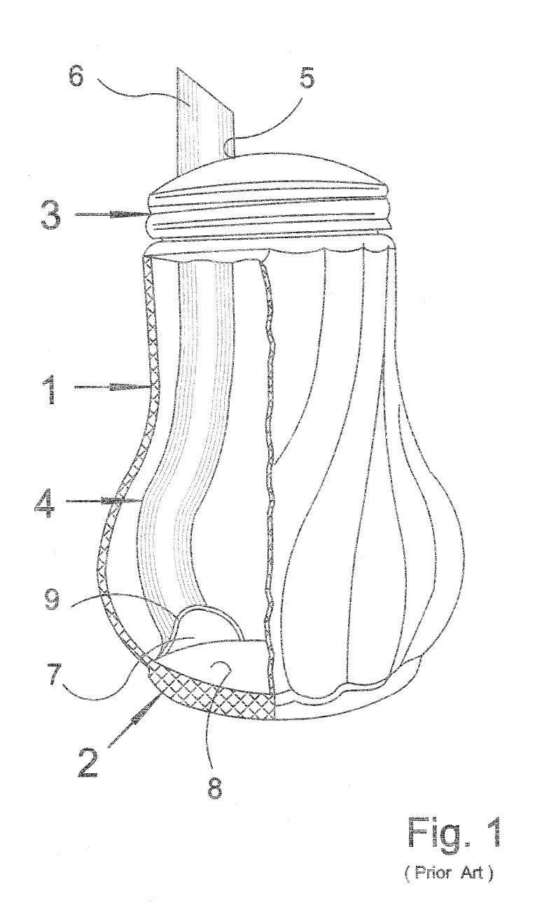

FIG. 1 shows a dispenser container in the form of a measurer for sugar, for purposes of explanations. The container comprises sidewalls 1, a container bottom 2, a container cover 3 and a discharge insert 4. The container bottom and the container sidewalls are integrally formed whereas the container cover 3 can be screwed on an upper neck portion of the sidewalls. The container cover 3 includes an opening 5 where the discharge insert 4, together with a spout 6, extends through. The discharge insert 4 is constructed as a tube or shaft having a metering or measuring opening 7 at its lower end. The measuring opening is partially limited by the upper side 8 of the container bottom 2 and partially by the wall 9 of the discharge insert 4. Furthermore, the measuring opening 7 is arranged at the rim of the container bottom 2, that is, the upper face 8 thereof.

When flowing solids, for example sugar, has been filled in the dispenser container and the dispenser container is positioned obliquely, the upper face 8 of the bottom 2 is effective as a sliding surface for the good or product filled in so that, when the dispenser container is positioned appropriately, a portion or quantity of the product is being pushed into the tube or shaft of the discharge insert. When completely tipping or dumping the dispenser container, this portion is dispensed via the spout 6.

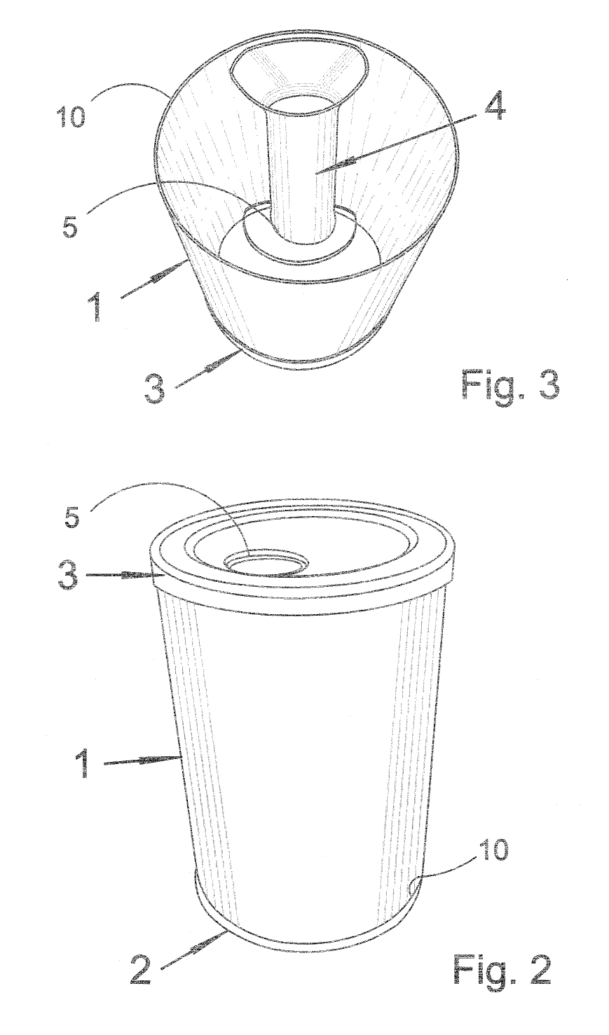

FIGS. 2, 3 and 4 show a can as an embodiment of a dispensing device of invention. The same reference numbers are used for functionally corresponding parts with the dispensing container of FIG. 1. The sidewalls 1, the container bottom 2 and the container cover 3 can be made up of coated sheet material, plastics, multilayer material or paste board. For the discharge insert 4, plastics is preferred, though also sheet material, multilayer material or paste board can be used as the wall material for the discharge insert.

The discharge insert 4 extends from the opening 5 in the container cover 3 to near the rim 10 of the container sidewall where the container bottom 2 is fastened, and forms a shaft having a tube section 11 and a funnel section 12. For fixing the discharging insert 4 at the container cover 3, a fixing section 13 is provided. As shown, the funnel 12 is cut obliquely so as to form the measuring opening 7 as an inlet into the shaft. As best seen from FIG. 3, the dispensing can may be filled-in from the side of the container bottom as far as the container bottom is not yet fixed to the rim 10 of the container sidewall. The empty dispensing container, therefore, is filled with the lower container side up, however, without container bottom. The dispensing container filled in this manner is closed by attaching the container bottom 2.

Before using the product the opening 5 is closed in an appropriate manner by cover, breakable foil or sheet or similar, and is opened to take off product. It is possible to fit-in a shout 6 in the opening 5 for conveniency in operation. The dispensing of product is in the manner described in FIG. 1 by positioning the dispensing container obliquely and following tipping.

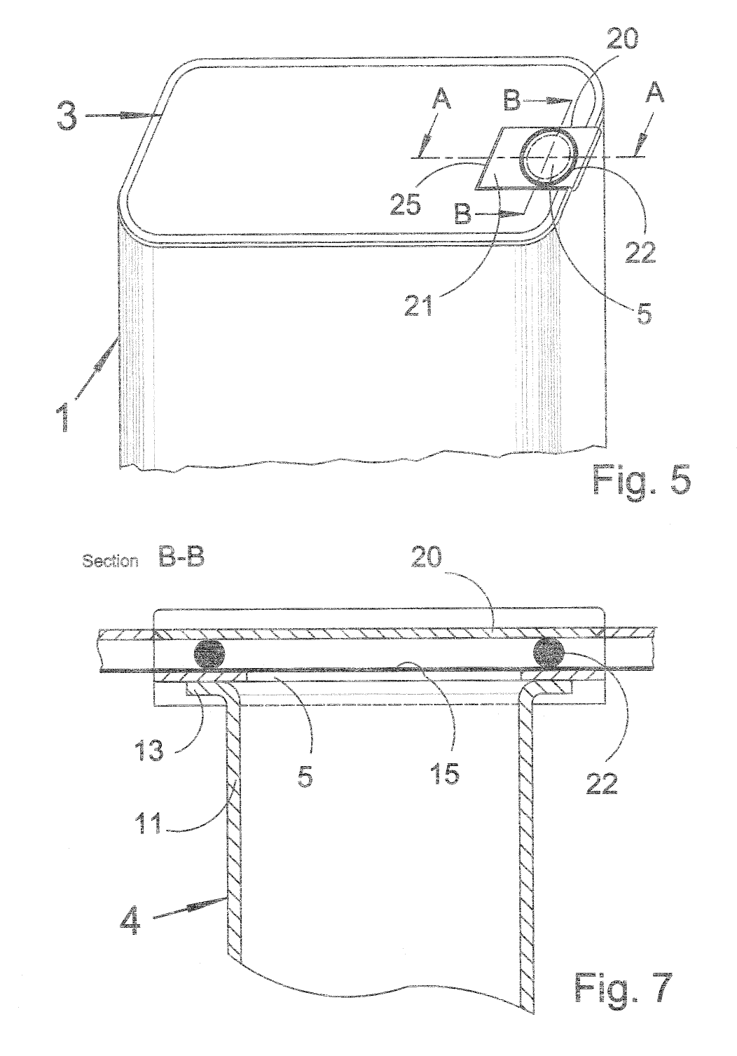

FIGS. 5 through 7 show a dispensing container in the shape of a box. Functional parts corresponding to the dispensing container of the embodiments already described carry the same reference numbers. The same materials can be used as described. For filling the dispensing container, the lower side can be turned up where the container bottom is absent.

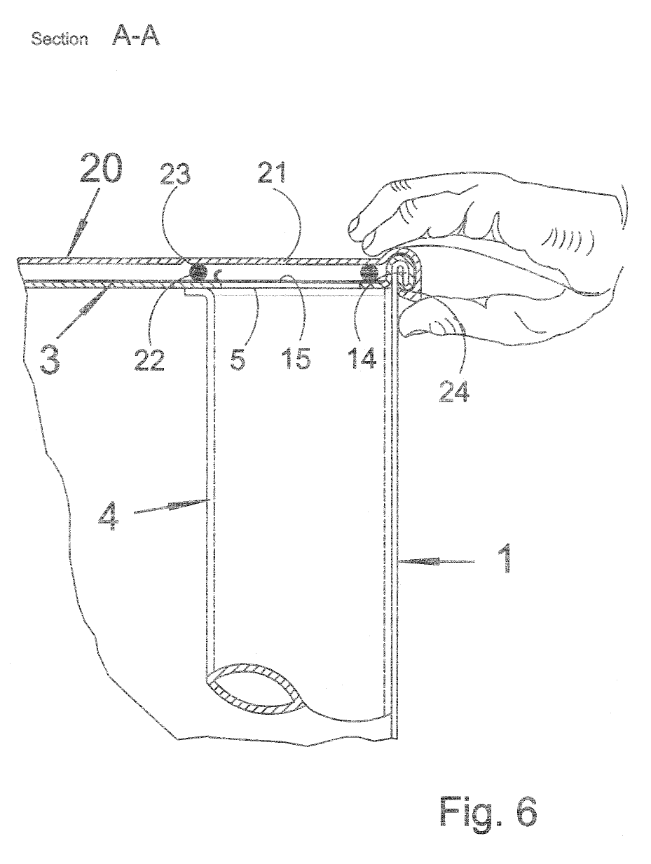

The opening 5 in the container cover 3 is used as dispensing opening. This dispensing opening is closed by a tamper indicating breakable foil or sheet 15 (FIGS. 6, 7). The cover 15 can consist of a sealed aluminum sheet or foil having a breakable tab. Furthermore, a dispensing opening closure 20 is provided, that is, a device for subsequently closing the dispensing opening that comprises a hinged cover 21 and a seal 22. The seal 22 encircles the opening 5 as a ring and may consist of cellular rubber. The hinged cover 21 has a hinge 23. The rim of the hinged cover 21 opposite to the hinge 23 comprises a latching hook 24 that can be clipped over the flange 14 between cover 3 and sidewall 1, so as to fix the hinged cover 21 and seal the opening 5.

In FIG. 5, a molded film 25 is provided for fixing the hinged cover 21 at the upper side of the cover 3. This molded film can be used simultaneously as a hinge for the hinged cover 21. A living hinge as shown at 23 in FIG. 6 can be used for the hinged cover additionally or alternatively.

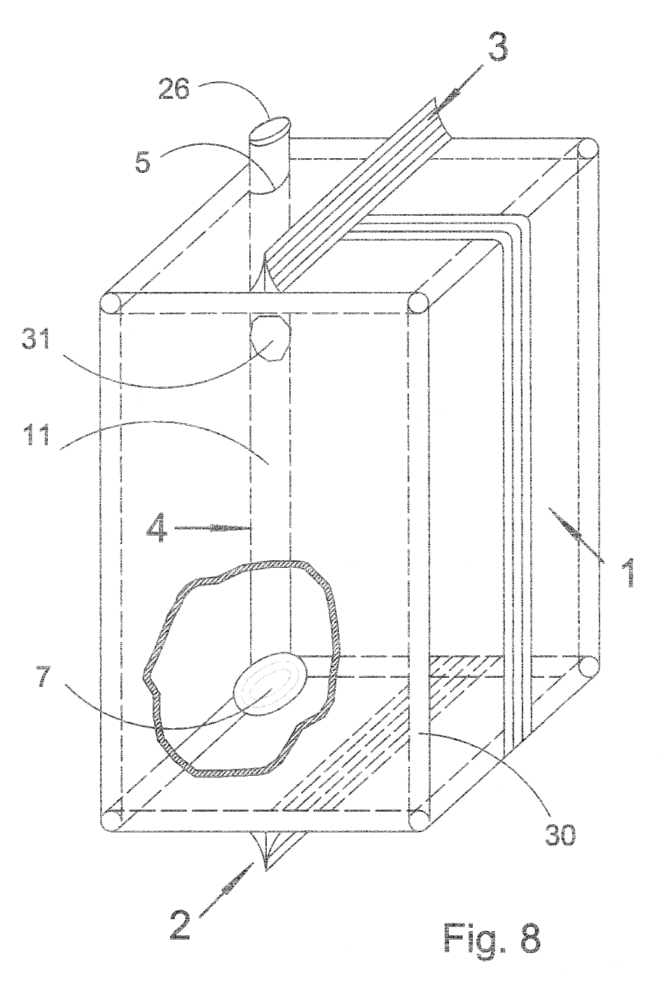

FIG. 8 shows an embodiment with a tube bag formed as a dispensing container. The same reference numbers are used for similar functional parts of the previous embodiments. Tube material forms the walls 1 of the container. The container bottom 2 and the container cover 3 are formed by weld seams so to say. The dispensing insert is formed by a tube 11 having a measuring opening 7. In the region of the bag upper side 3, there is an opening 5 where the dispensing insert extends outwardly. A cap 26 or a screw lid is used to close the outer end of the dispensing insert and may be removed for dispensing product. The tubular bag can be stabilized by an inner frame 30, for example of plastics, that is connected to the discharging insert as at 31. The frame 30 spans the sidewalls of a box of tube material. The frame 30 can also be formed so as to span only a bottom sliding surface. Operation of the filled tube bag corresponds to the manner already described.

When producing the dispensing container from tube material, a seam is let open for filling the bag and subsequent welding. It is preferred to fill the bag in normal position, that is, to shut the weld seam in the region of the cover wall after the filling operation.

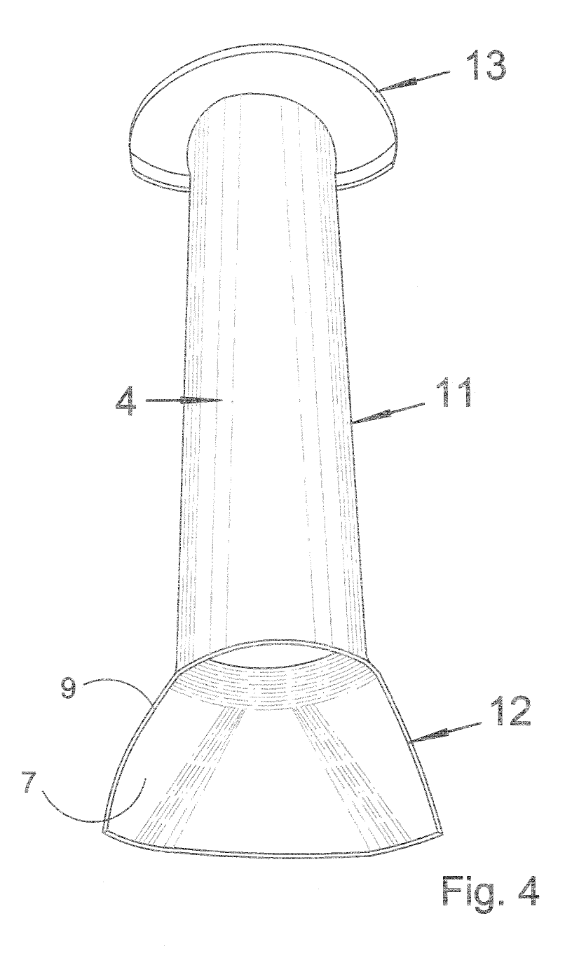

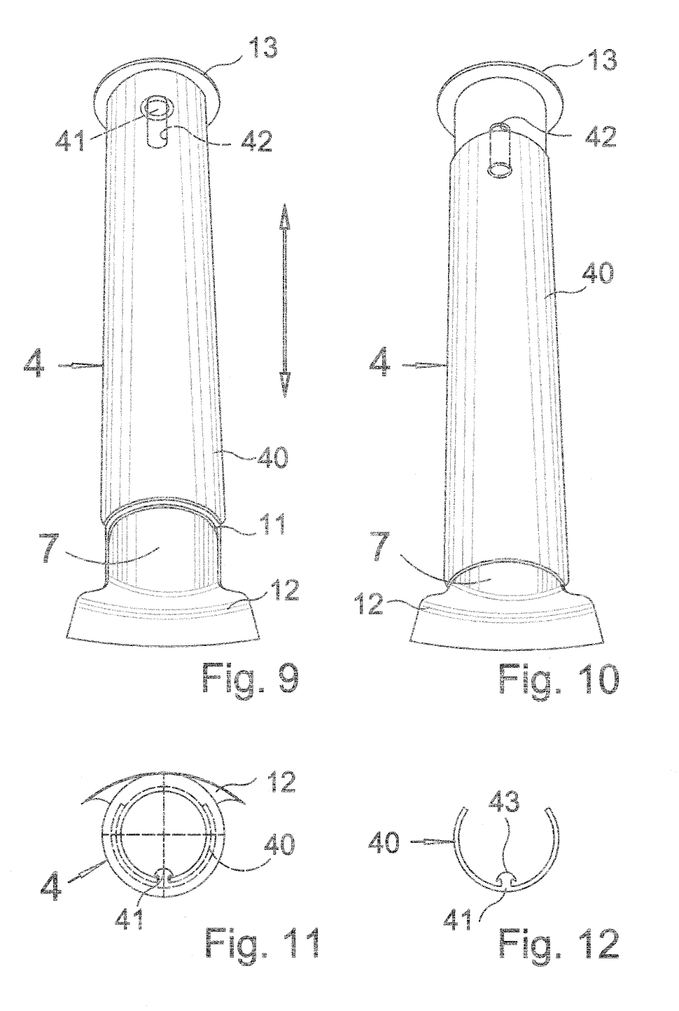

FIGS. 9 through 12 show a further embodiment of the discharging insert 4, namely having a variable dispensing opening. There is a basic body corresponding to some extend to the discharging insert of FIG. 4, the reference numbers thereof are used for corresponding parts. Furthermore, a slider 40 is provided that enables to change the size of the measuring opening 7, and that between a maximum opening position as shown in FIG. 9, and a minimum opening position as shown in FIG. 10. The slider 40 grips over the tube section 11 and thus is guided between the maximum and minimum opening positions of the measuring opening 7. In the embodiment shown, the slider 40 comprises a lug 41 arranged near the upper end of the slider 40 and extending into the tube 11 through a slot 42. In this manner, the slider 40 can be adjusted by means of a finger of a human hand, since there is access to the lug 41 for the finger through the opening 5, if the container cover 3 is removed. The lug 41 advantageously has a mushroom head 43 that is pressed through the slot 42 when assembling the slider 40 and spreads behind the slot 42 so as to hold the slider 40 at the tube section 11. In order to show the quantity measured, it is possible to attach a tongue having markings onto the mushroom head 43, the tongue protruding at the opening in the cover 3, the protruding length being a measure of the quantity size dispensed.

In a modified embodiment, the slider 40 can be turned and has a covering vane that can be moved in an out of the measuring opening 7 so as to adjust the effective opening size.

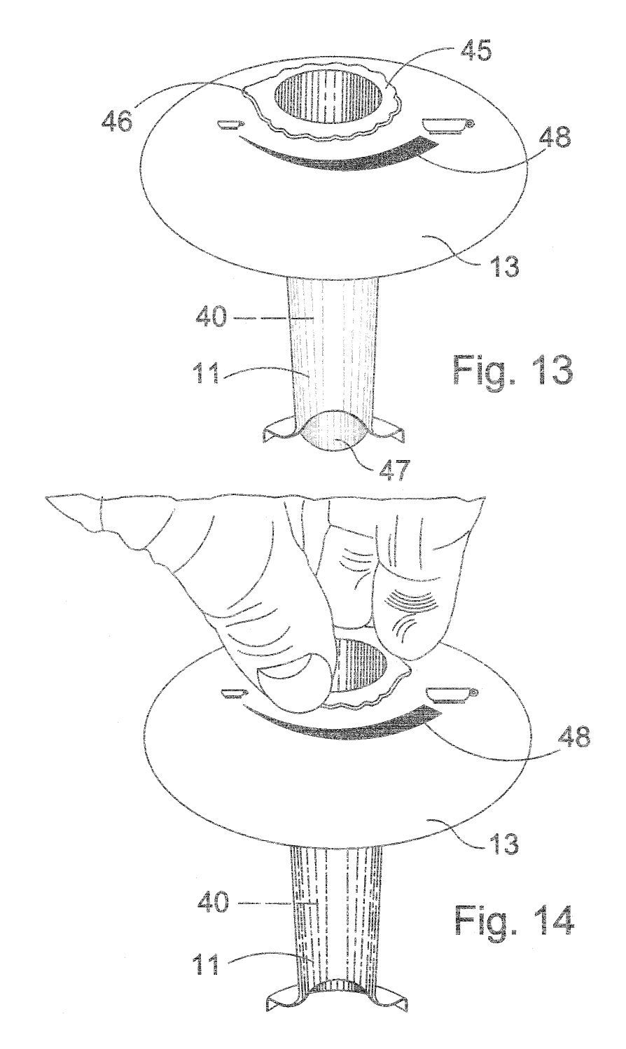

FIGS. 13 and 14 show a discharging insert 4 having a rotational slider 40 formed as a slotted tube fitted into the shaft or tube section 11 and spreading there to some degree so as to keep the position taken. The upper end forms a collar 45 having a pointer 46, and the lower end has a covering vane 47 that has been turned before the measuring opening 7 in FIG. 13. The fixing section 13 carries a marking 48 on its upper side that chose, together with the pointer 46, the quantity set for being dispensed.

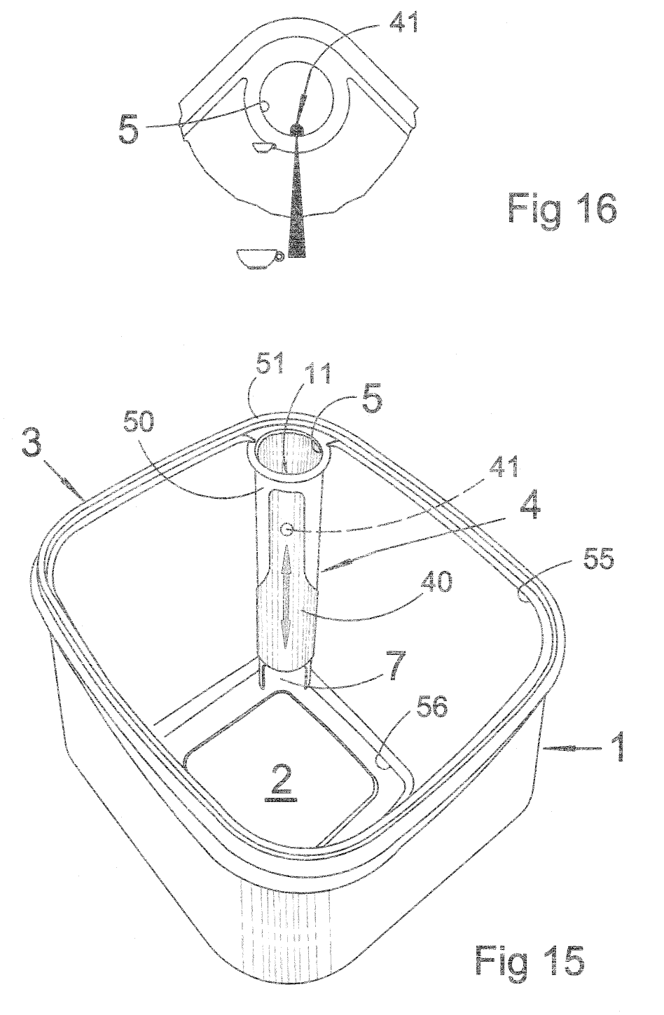

FIGS. 15 through 18 show a further box-like embodiment of the dispensing container. Functionally similar parts of this dispensing container are called with the same reference numbers as in the embodiments already described. Thus, there are container walls 1, a container bottom 2, and a container cover 3. FIG. 15 shows the latching rim of the container cover 3 omitting the central cover wall so as to show the dispensing insert 4 in the interior of the dispensing container. The container can be produced in press or injection molding technology and can be recycled completely. It is possible to inject molding the container walls 1, the container bottom 2, and guiding wall portions 50 of the dispensing insert 4 in one piece. The guiding wall portions 50 that extend along the interior of the container along an edge 51 thereof are used to guide a slider 40 defining the size of the measuring opening 7. The guiding wall portions 50 and the slider 40 form a shaft 11 leading to the opening 5 in the container cover 3. The slider comprises a lug 41 that can be operated through the shaft interior so as to adjust the size of the measuring opening 7 and, therefore, also the size of the dispensing quantity. In FIG. 16, this possibility is indicated by a small and a big coffee cup.

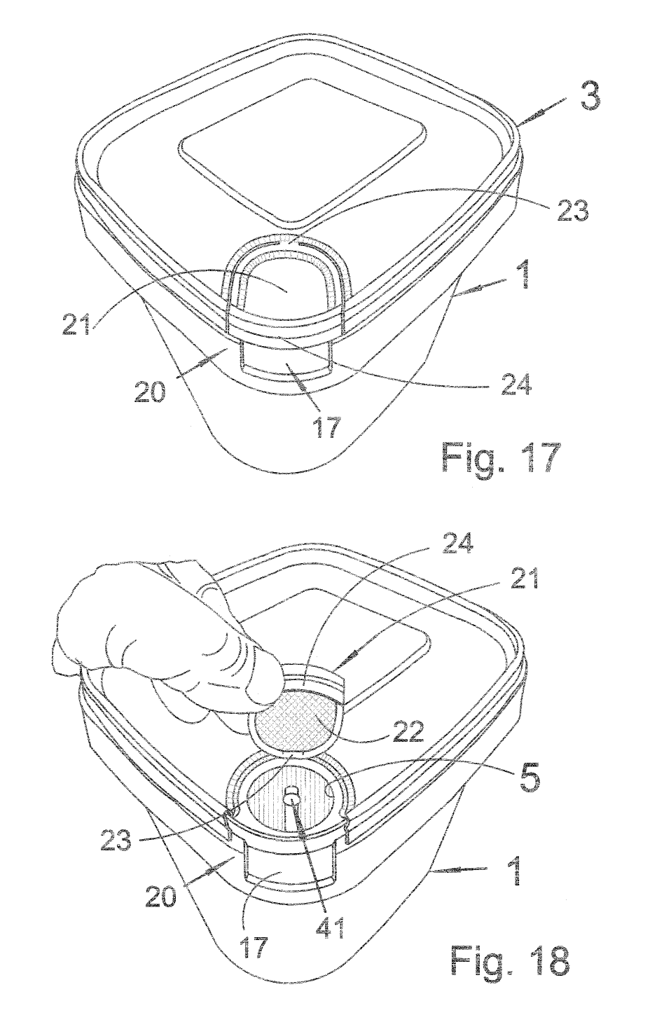

The opening closed by the container cover 3 may be provided with a tamper-indicating closure that may consist of a breakable foil or sheet as shown in FIGS. 6 and 7 at 15. Similar to the embodiment of FIGS. 5 through 7, a device for subsequent closing of the dispensing opening 5 is provided that is formed as a closure 20 in the corner of the cover, see FIGS. 17 and 18. The closure 20 comprises a hinged cover 21 and a seal 22 so as to seal the opening 5. The hinged cover 21 is linked at the main body of the container cover 3 by a hinge 23 that can be a living hinge. The hinged cover 21 has a latching rim 24 so as to grip the rim of the container wall 1 and to latch therewith. The originally closed position of the hinged cover 21 can be warranted by a tamper-indicating band 17 (FIG. 17).

The operation with the dispensing container of FIGS. 15 through 18 corresponds to the embodiments already described. The hinged cover 21 will be opened, the opening 5 is cleared, and the dispensed quantity will be set by operation of the lug 41, as the case is. By tipping the dispensing container with the dispensing opening 5 downwardly, a respective quantity of flowing product can be dispensed.

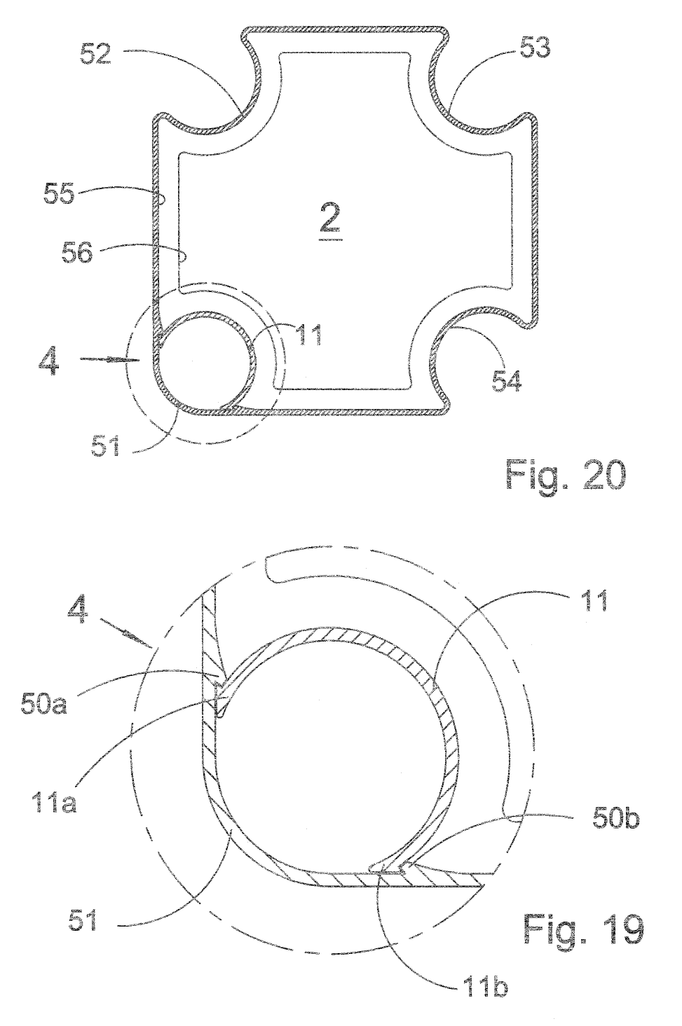

FIG. 19 shows a further possibility of constructing the discharging insert 4. As in the case of the embodiment of FIG. 15, guiding wall portions 50a, 50b extend parallel to the edge 51 and have an undercut. The shaft wall 11 has hook-shaped ends 11a, 11b which form, together with the undercut at 50a, 50b, a dovetail guide. The shaft wall 11 can be produced so that, after assembly, a larger or smaller measuring opening 7 is formed, as desired. It is also possible to provide a slider similar to the rotational slider in FIGS. 13, 14 or the slider 40 in FIG. 15 and mount the same at the shaft wall 11 so as to provide an adjustable dispensing device.

In order to create the possibility of stacking of empty containers, the sidewalls of the dispensing containers taper. In the embodiment shown, the container bottom 2 has a smaller basis area 56 in relation to the basis area 55 of the container cover 3. In the case of a can-like dispensing container, a section of a cone is formed, and in the case of a box-like dispensing container, a section of a polyeder (polyhedron) is formed preferably having four sidewalls 1. With the shape of a polyeder, the dispensing insert 4 is arranged in one (51) of the edges of the polyeder. For the purposes of stacking empty containers it may be convenient to construct the guiding wall portions 50, 50a, 50b resiliently and/or as small as possible, as shown in FIG. 19 such that the basic bodies 1, 2 of the dispensing containers (that is, without shaft wall 11 or slider 40) can be stacked into one another, if rotated by a quarter turn.

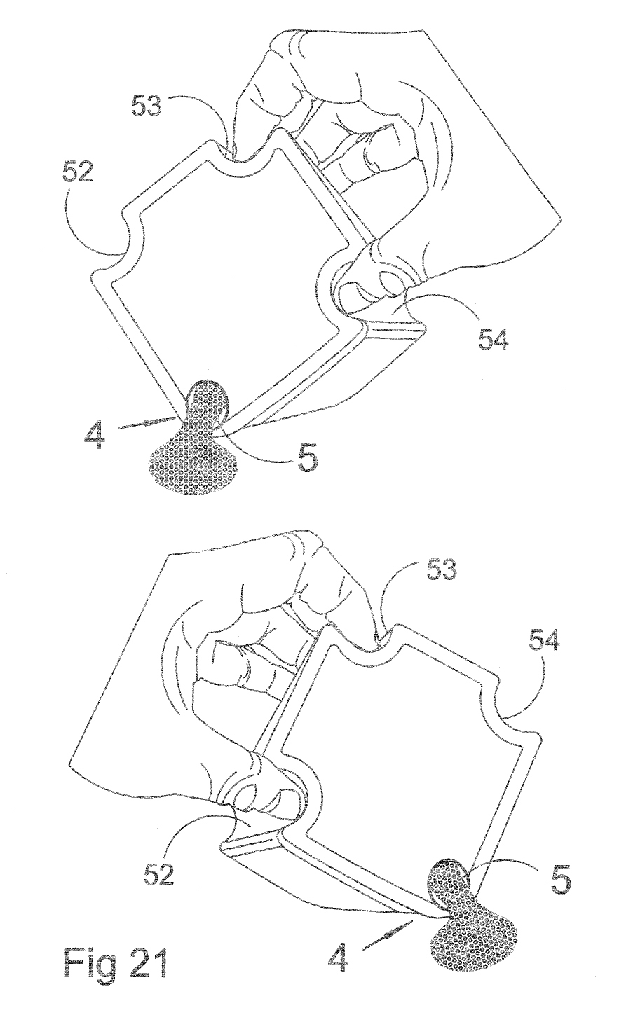

FIG. 20 shows a further embodiment of the dispensing container where the discharging insert 4 of FIG. 19 is clipped into the edge 51 of the container. The dispensing container of FIG. 20 has the particularity of recess edges 52, 53, 54 with the exception of edge 51. As shown in FIG. 21, gripping of the container for right-handers and left-handers is enhanced.

The dispensing containers of FIG. 20 can be stacked. For that purpose, the area of the opening for the container cover 3 tapers to the bottom 2. Thus, the basic body 1, 2 of the dispensing container forms a larger basis area 55 and a smaller basis area 56. Due to this provision, dispensing containers can be stacked into one another. This is true for sections of polyeders (polyhedrons) with or without recesses at the edges as well as for sections of cones. In all these cases, the clipsable shaft wall 11 is mounted just before filling the dispensing containers.

As shown in FIG. 21, the embodiment with free recesses 52, 53, 54 offers convenient operation by right-handers and left-handers, right-handers gripping into the recess 54 with the thumb and with the fingers in the recess 53, whereas left-handers grip into the recess 52 with the thumb and into 53 with the fingers. This holds true independently whether the dispensing container tapers or has a prismatic shape. The user can tip the dispensing container such that the dispensing opening 5 is at the lower corner of the dispensing container where in FIG. 21 just dispensed good (for example coffee powder) exits.

If the sidewalls 1, the container bottom 2 and portions 50, 50a, 50b of the dispensing insert 4 are integrally formed by injection molding, the IML-method (in-mold labeling) can be used, where the outer decoration of the container is produced in one step with the body of the container. This enables multi use of the tooling for producing the basic body of the container for different products and different producers. The following applications are possible:
a) basic body used for adjustable metering
b) basic body used for fixed metering
c) basic body used without metering, however dispensing at the edge closure 20
d) basic body used for non-fluent product, including a container cover without edge closure.

The invention provides a metering system for flowable products where the single portions need not be packaged individually. The customer has the possibility to define the size of the single portions by choosing the size of the metering opening. After dispensing of good, the dispensing container can be closed again. Thus, the product filled in can be kept fresh and prevent it from exhaling. It is remarkable that when dispensing good, only the space within the dispensing insert gets into contact with fresh air, however, not the larger inner space of the dispensing container that does not undergo air exchange and thus is less exposed to exhaling.

It is of special advantage that the production of filled dispensing container can be carried out in a simple manner. The empty dispensing container is provided with a discharging insert, one side of the container being left open. In the case of cans opening box-like containers, the lower side of the container can be chosen as filling side. In the case of injection molded containers with portions of the dispensing insert being in situ molded, the cover side of the container is preferred as the fill-in opening. In the case of tube bags, a weld seam is left open to fill the bag. Subsequently, the filled dispensing container is closed by attaching the container bottom in the case of a can, or attaching the container cover in the case of injection molded containers, or the seam is welded in the case of tube bags.

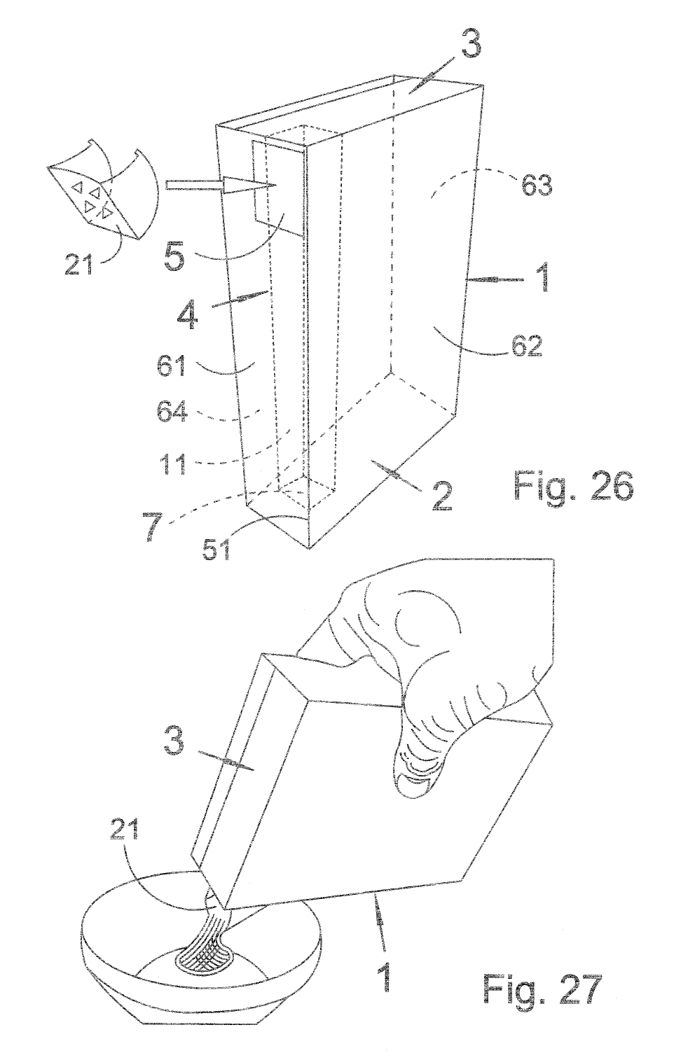

Reference is made to FIG. 26. The dispensing container comprises sidewalls 1 forming a jacket, a container bottom 2 and a container cover 3 where the jacket is formed of four wall sections 61, 62, 63, 64 of a blank. The wall sections 61 and 63 form the narrow faces of the box and the wall sections 62 and 64 the larger faces of the box. Within the box, a dispensing device 4 is shown in dashed lines having a dispensing opening 5. The discharging device 4 can be opened and closed by a flap 21. The discharging device 4 forms a shaft 11 that extends along an edge 51 from the container cover 3 to the metering opening 7 near the container bottom 2.

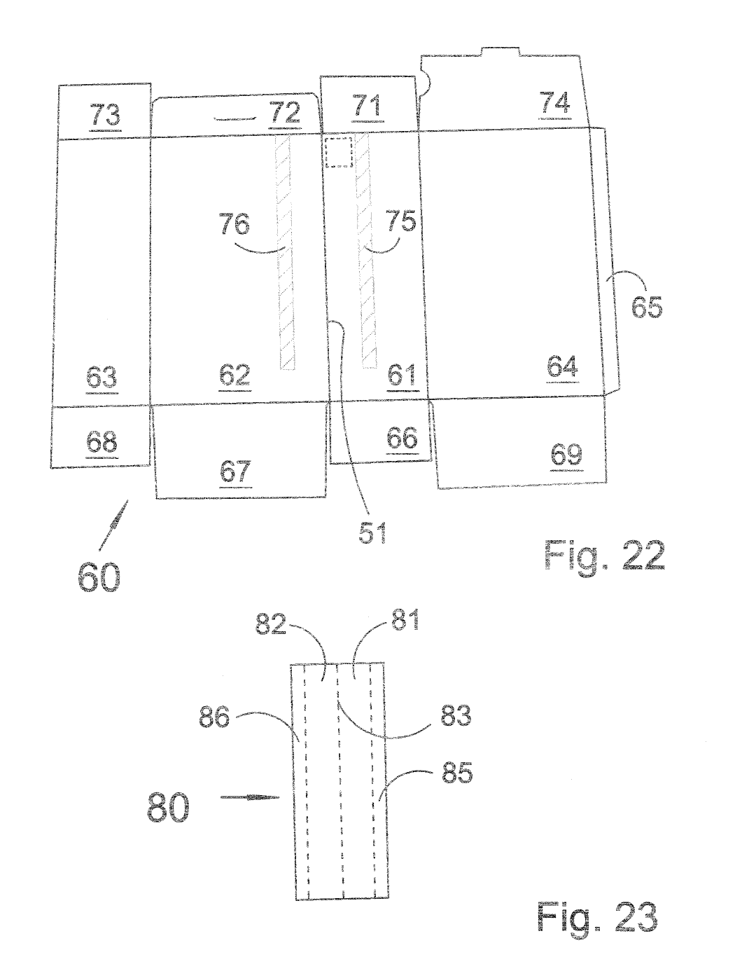

The production of the dispensing container is described with FIGS. 22 through 25. The first step is the production of a blank 60 of sheet material containing the wall sections 61 through 64 and a strip 65 for forming the container jacket 1. For forming of the container bottom 2, further tab-like wall sections 66 through 69 are used. The container cover 3 is formed with tab-like wall portions 71 through 74. The wall portions of the blank are connected by folding lines where the folding line 51 has a special significance. A pair of prepared fixing stripes 75, 76 extend parallel to this folding line 51 and are used for fixing a stripe 80 of flat material (FIG. 23). The flat material stripe 80 comprises a pair of wall sections 81 and 82 which are connected by a folding line 83 and to which lateral stripes 85, 86 join. The stripes 85, 86 of the flat material stripe 80 are put onto the fixing stripes 65, 76 and fastened to the blank 60 in suitable manner. Gluing, hot sealing or hot welding are considered.

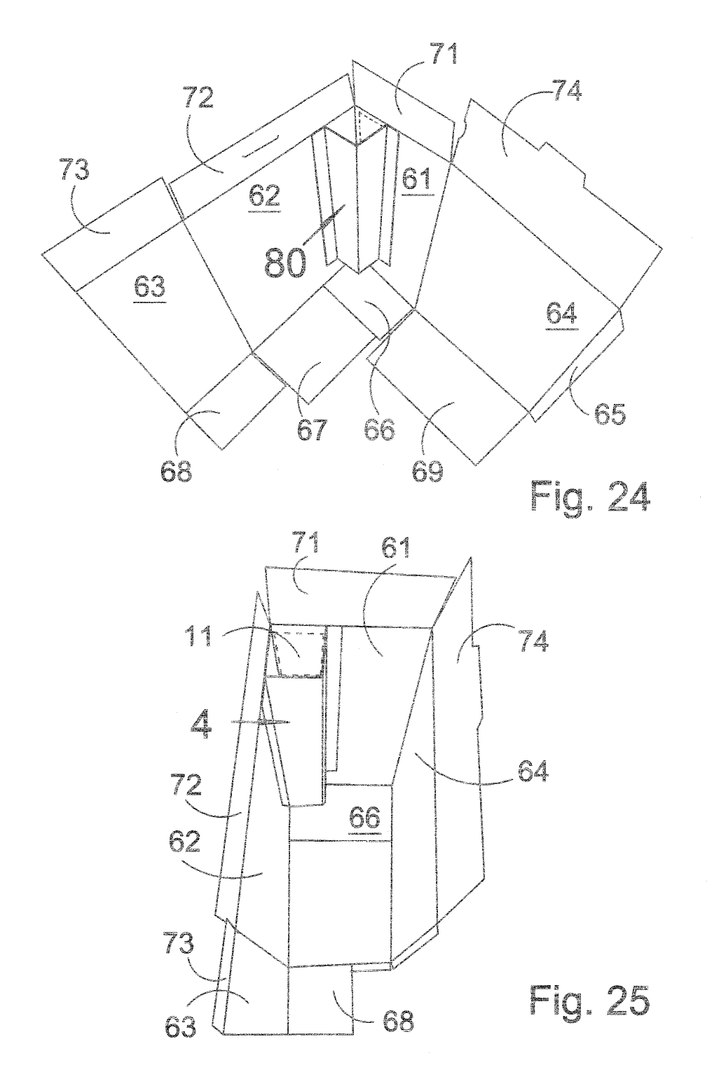

FIGS. 24 and 25 show subsequent folding of the box. The discharging device 4 including the shaft 11 is formed by folding up the flat material stripe 80.

As sheet or flat material, coated paste board can be used. The coating can include aluminum foil or another coating making the flat material impermeable. Also barrier layers of synthetics can be used. In order to enable hot sealing, the flat material may include seal foil or seal film. The cut edges of the blank may be provided with hot melt material in order to produce a dispensing container showing some kind of exhaling barrier.

FIG. 27 shows how to use the dispensing container. By pulling out the flap 21, the dispensing opening 5 is cleared, and by tipping of the dispensing container, a metered portion of the product is dispensed. When the dispensing container is tipped back, the space at the metering opening 7 fills with good, and a new portion can be dispensed by new tipping.

The following claims are presented for examination:

1. A dispensing container for a flowable product made up as a selling package, comprising:
container sidewalls, a container bottom connected to said sidewalls, a container cover and discharging means for dispensing portions of the product,
the discharging means forming a shaft that extends from a dispensing opening to said container bottom and includes a metering opening at the container bottom arranged at a rim of the container bottom, such that, when the dispensing container is held obliquely, a portion of the product is fed into the metering opening, and when tipping the dispensing container, this portion is discharged through the shaft and the dispensing opening,
wherein said container sidewalls provide a basic shape of a quadrilateral polyhedron having one edge formed by a pair of said sidewalls that form sliding surfaces for the product to said edge,
wherein the discharging means is arranged in the angular region of this edge, and
wherein the dispensing container includes means for sealingly closing the container.

2. The dispensing container of claim 1
wherein said pair of sidewalls include guiding wall portions in the angular region of said edge, said guiding wall portions holding a shaft wall inserted for forming said discharging shaft.

3. The dispensing container of claim 2
wherein said shaft wall has hook-shaped ends for gripping behind said guiding wall portions.

4. The dispensing container of claim 2
wherein said guiding wall portions are shaped to guide a slider forming said shaft wall and keeping a distance to said container bottom to form a metering opening with an adjustable size.

5. The dispensing container of claim 4
wherein the slider is a rotational slider and includes a collar with a pointer for determining and showing said size of said metering opening.

6. The dispensing container of claim 4
wherein the slider comprises a tab arranged for being operated by a finger of a hand for adjusting said slider.

7. The dispensing container of claim 6
wherein said tab extends through a slot in said shaft wall and comprises a mushroom head within said shaft.

8. The dispensing container of claim 1
wherein said dispensing opening is arranged in said container cover and is closed by a breakable sheet or foil.

9. The dispensing container of claim 1
wherein said dispensing opening is provided with a sealing closure.

10. The dispensing container of claim 9
wherein said closure comprises a hinged cover and a seal encircling said dispensing opening.

11. The dispensing container of claim 10
wherein said hinged cover is fastened to said container cover by means of a living hinge.

12. The dispensing container of claim 10
wherein said hinged cover comprises a latchable rim.

13. The dispensing container of claim 1
wherein said edge between said pair of sidewalls is a rounded edge.

14. The dispensing container of claim 1
wherein said basic shape of a polyhedron is tapering and comprises a larger basis area and a smaller basis area, said smaller basis area forming said container bottom and said larger basis area forming an opening that is covered by said container cover.

15. A container basic body comprising:
container sidewalls and a container bottom that are injection-molded integrally in one piece, thus forming a container bottom surface and a container opening that can be closed by a container cover,
said container sidewalls comprising guiding wall portions extending from near said container bottom to said container opening and being provided with undercut portions for holding an insertable discharging device,
said container opening having a larger area than said container bottom area and said container sidewall tapering to said container bottom for making said container basic body fit for stacking with other basic bodies.

16. The container basic body of claim 15
wherein said container sidewalls include a pair of sidewalls forming an edge, said guiding wall portions extending in the angular region of said edge from said container opening to near said container bottom and being resiliently constructed.

17. A dispensing container in the form of a can for flowable product comprising:
a container sidewall, a circular container bottom connected to said sidewall, a circular container cover and discharging means for dispensing portions of the product,
wherein said discharging means form a shaft that extends from a dispensing opening to said container bottom and includes a metering opening at said container bottom arranged at a rim of the container bottom such that, when the dispensing container is held obliquely, a portion of the product is fed into the metering opening, and when tipping the dispensing container, this portion is discharged through said shaft and said dispensing opening,
wherein said container sidewall comprises coated sheet material, paste board or multilayer material and is formed to a round cylindrical body having a first and a second peripheral rims,
wherein said container bottom comprises coated sheet material or paste board and is attached at said first rim of said container sidewall,
wherein said container cover comprises a breakable aluminum foil or sheet that is attached at said second rim of said container sidewall, and a further plastic cover member that can be stuck onto said second rim of said body, and
wherein said discharging means is a separate member fixed onto said aluminum foil or sheet.

18. A dispensing container for a flowable product made up as a box, comprising:
a blank of flat or sheet material that includes wall sections for forming container sidewalls, a container bottom and a container cover, a discharging device that forms a shaft between a dispensing opening near said container cover and a metering opening near said container bottom,
wherein a pair of wall sections of the container sidewalls that are connected with a folding line, are bridged by a flat material stripe having longitudinal rims that are fixed onto said pair of wall sections, and
wherein said shaft is formed by folding up of said flat material stripe when folding the box about said folding line.

19. The dispensing container of claim 18
wherein said flat or sheet material contains a seal foil enabling fastening of said rims of said flat material stripe at said container sidewalls in a hot melt process.

20. The dispensing container of claim 18
wherein said flat or sheet material is impermeable to gas.

21. The dispensing container of claim 18
wherein said flat material is coated paste board.

22. The dispensing container of claim 21
wherein the coating of the paste board includes aluminum foil.

23. The dispensing container of claim 21
wherein the coating of the paste board includes plastic layers.

24. The dispensing container of claim 18
wherein said wall sections of said flat material blank cut edges comprise sealed by hot melt material.

25. A dispensing container for a flowable product comprising:
means forming a container sidewall, a container bottom, a container cover and discharging means for dispensing portions of the product,
wherein said discharging means forms a shaft that extends from a dispensing opening to said container bottom and includes a metering opening at said container bottom arranged at a rim of said container bottom such that, when the dispensing container is held obliquely, a portion of the product is fed into said metering opening, and when tipping the dispensing container, this portion is discharged through said shaft and said dispensing opening,
wherein said container sidewall, said container bottom, said container cover and said discharging means comprise one of coated sheet material, paste board, multilayer material or plastics,
wherein said container sidewall is formed to a cylindrical body having a first and a second peripheral rims, said container bottom being attached at said first rim of said container sidewall,
wherein a breakable cover sheet is attached to said second rim of said a container sidewall,
wherein said shaft of said discharging means is fixed to said breakable cover sheet encircling said dispensing opening, and
wherein said container cover is formed to grip said second rim of said cylindrical body.

26. The dispensing container of claim 25,
wherein said breakable cover sheet comprises a aluminum foil and
wherein said container cover comprises plastics.

27. The dispensing container of claim 25,
wherein a dispensing opening shutter is provided in the region of the dispensing opening arranged between said cover sheet and said container cover and including a hinged cover and a seal.
